(19) United States
(12) Patent Application Publication
(10) Pub. No.: US 2021/0084866 A1
(43) Pub. Date: Mar. 25, 2021

(54) DOG WASTE CONTAINER

(71) Applicant: Lisa Tomlin, Woodale, IL (US)

(72) Inventor: Lisa Tomlin, Woodale, IL (US)

(21) Appl. No.: 17/026,259

(22) Filed: Sep. 20, 2020

Related U.S. Application Data
(60) Provisional application No. 62/902,483, filed on Sep. 19, 2019.

(51) Int. Cl. A01K 27/00; A01K 23/00; E01H 1/12

(52) U.S. Cl. CPC A01K 27/008; E01H 2001/1286; E01H 1/12; A01K 23/00

(57) ABSTRACT

The present invention is a dog waste container for holding pet waste, bags, sanitary items and other dog walking needs. A thin nylon piece or material that is attached to the plastic device may be shaped like a fire hydrant. The nylon component forms a loop strap with a clasp that can be attached to a dog's harness, leash handle or be held by a user. The device has two separate compartments. The top compartment has a twist off top and drop down holding area for waste bags and the bottom compartment is the inside area of the device where the waste filled bag is paced and contained. An outer mesh pocket is available for keeping sanitary wipes, hand sanitizer, or any other items that need to be ready accessible.

This application claims priority to U.S. provisional application 62/902,483, filed on Sep. 19, 2019; the disclosure of which are hereby incorporated by reference in its entirety.

### BACKGROUND OF THE INVENTION

### Field of the Invention

The present invention is in the field of pet accessories. More specifically, the present invention is a dog waste container.

### Background of the Invention

The present invention is a dog waste container that may be shaped like a red fire hydrant. When walking a dog inevitably a waste-filled bag becomes an issue. It is cumbersome to carry pet waste, new bags and sanitary wipes, all while trying to walk a dog. Many times before the bag can be discarded, the waste filled bag leaks or completely breaks, creating an unsanitary mess.

The present invention reduces the mess with a container that holds pet waste, extra waste bags, treats for the dog, sanitary items and all other dog walking needs. The present invention device can be used to transport pet waste in an easy and discreet manner keeping hands clean and empty. An attachment enables the container to be affixed to a dog harness, leash handle or carried by the dog walker. In use, the container prevents waste filled bags from tearing or leaking during transport and the device reflects light for safety when walking your pet in the dark.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a dog waste container, in accordance with one embodiment of the present invention.

FIG. 2 illustrates a dog waste container, in accordance with one embodiment of the present invention.

FIG. 3 illustrates a dog waste container, in accordance with one embodiment of the present invention.

FIG. 4 illustrates a dog waste container, in accordance with one embodiment of the present invention.

FIG. 5 illustrates a dog waste container, in accordance with one embodiment of the present invention.

FIG. 6 illustrates a dog waste container, in accordance with one embodiment of the present invention.

FIG. 7 illustrates a dog waste container, in accordance with one embodiment of the present invention.

FIG. 8 illustrates a dog waste container, in accordance with one embodiment of the present invention.

FIG. 9 illustrates a dog waste container, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

A device or dog waste container that may be made of plastic for holding pet waste, bags, sanitary items and other dog walking needs. A thin nylon piece of material that is attached to the plastic device may be shaped like a fire hydrant. The nylon component forms a loop strap with a clasp that can be attached to a dog's harness, leash handle or be held by a user.

The device has two separate compartments. The top compartment has a twist off top and drop down holding area for waste bags and the bottom compartment is the inside area of the device where the waste filled bag is placed and contained. An outer mesh pocket is available for keeping sanitary wipes, hand sanitizer, or any other items that need to be readily accessible.

The sizes of the device are small to large. The device may be red symbolizing a conventional fire hydrant with two yellow reflective strips that run along the bottom of the lower compartment used to hold the waste bags. The reflective strips improve the visibility of both the dog and the walker especially useful during lowlight hours of the day. The exact size, measurement, construction and design specification may vary upon further development and manufacturer.

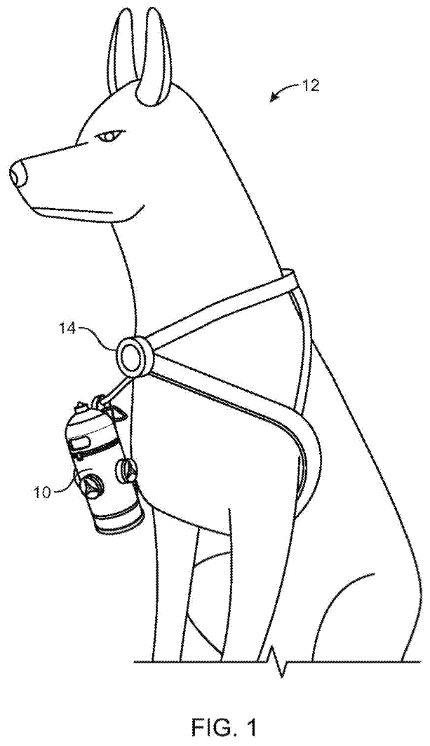

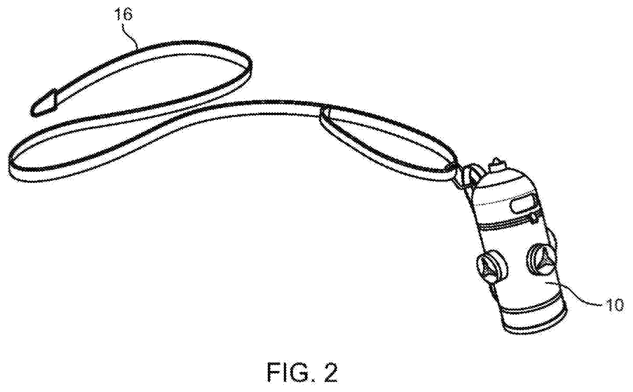

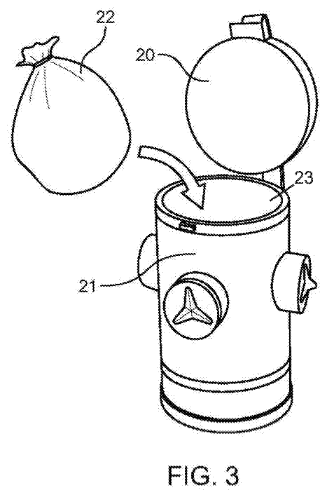

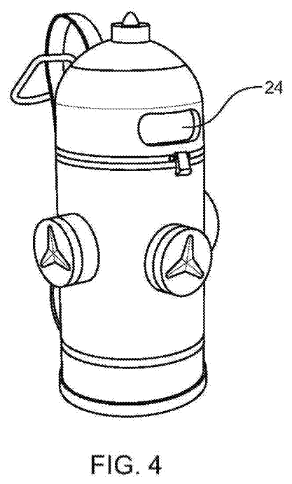

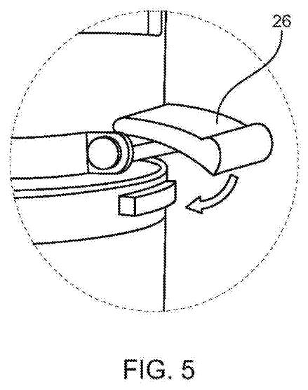

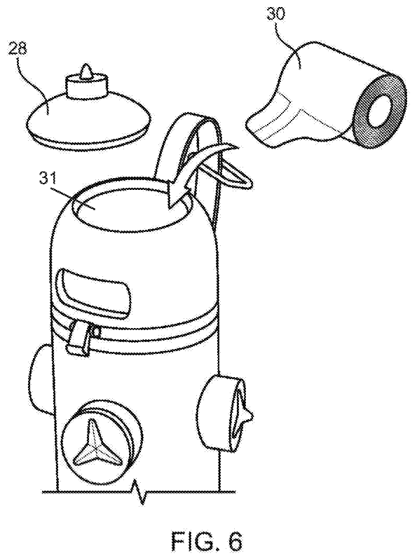

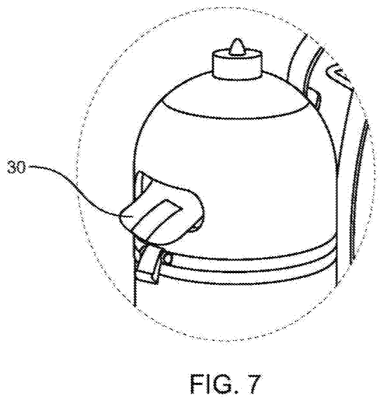

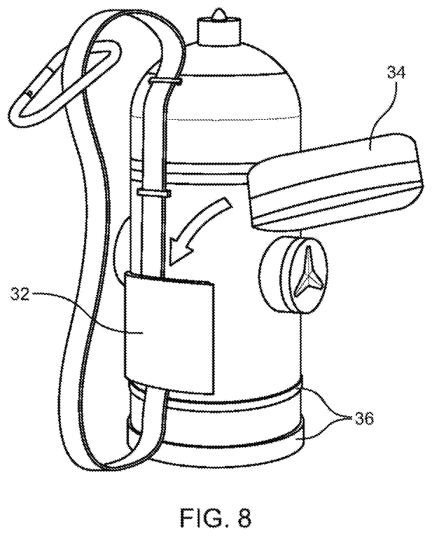

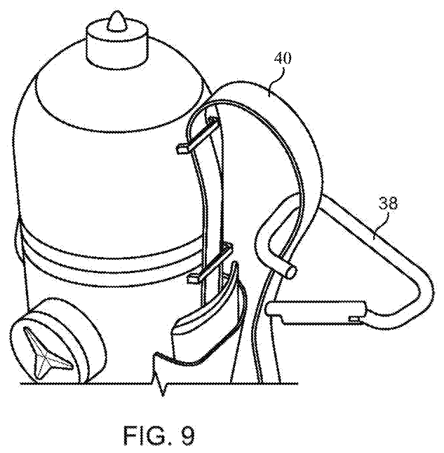

Referring now to FIG. 1, illustrated is dog waste container 10, in accordance with one embodiment of the present invention. In FIG. 1, illustrated is the dog waste container 10 attached to a harness 14 of a dog 12. Referring now to FIG. 2, illustrated a dog walker option to carry the dog waste container 10 shown is a leash 16 attached to the dog waste container 10. Referring now to FIG. 3, illustrated a top compartment 20 that is in an opened state and a bottom compartment 21, the bottom compartment 21 has an inside area 23. A waste filled bag 22 is shown being ready to be placed into the dog waste container 10 at the inside area 23. Referring now to FIG. 4, illustrated a waste bag slot 24. FIG. 5 illustrated is latch 26 securing top compartment 20 and bottom compartment 21. FIG. 6 shows a twist off cap 28 in the top compartment 20 for waste bags 30 to be inserted inside the top compartment 20 the waste bags 30 may be in a roll for convenience, inside the top compartment 20 there is a drop down holding area 31 to store the waste bags 30. FIG. 7 shows the waste bags 30 ready to be used by a dog owner. FIG. 8 shows an outer mesh pocket 32 keeping sanitary wipes 34, hand sanitizer, or any other items that need to be readily accessible. Also reflective strips 36 improve the visibility of both the dog and the walker especially useful during lowlight hours of the day. FIG. 9 shows a locking clasp component 38 that may be used to connect to a dog's leach, a dog's harness, a dog's collar or a dog walker's belt and loop 40 that may be made of nylon.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention

What is claimed is:

1. A dog waste container connected to a harness comprising:
a top compartment with a waste bag slot and twist off cap to add waste bags; and
a bottom compartment with an inside area for a filled waste bag that is attached to the top compartment by a latch.

2. The dog waste container connected to a harness according to claim 1 wherein the dog waste container is shaped to look like a fire hydrant.

3. The dog waste container connected to a harness according to claim 1 wherein an outside surface of the dog waste container has an outer mesh pocket for keeping sanitary wipes or hand sanitizer.

4. The dog waste container connected to a harness according to claim 1 wherein an outside surface of the dog waste container has reflective strips.

5. The dog waste container connected to a harness according to claim 1 wherein a locking clasp component is used to connect the dog waste container to a dogs harness.

6. A dog waste container carried by a dog walker comprising:
a top compartment with a waste bag slot and twist off cap to add waste bags; and
a bottom compartment with an inside area for a filled waste bag that is attached to the top compartment by a latch

7. The dog waste container carried by a dog walker according to claim 6 wherein the dog waste container is shaped to look like a fire hydrant.

8. The dog waste container to connect to a harness according to claim 6 wherein an outside surface of the dog waste container has an outer mesh pocket for keeping sanitary wipes or hand sanitizer.

9. The dog waste container carried by a dog walker according to claim 6 wherein an outside surface of the dog waste container has reflective strips.

10. The dog waste container carried by a dog walker according to claim 6 wherein a locking clasp component connected to the dog waste container is used to connect the dog waste container to a dog harness.

11. A dog waste container comprising:
a loop attached to the the dog waste container;
a top compartment with a twist off top, the twist off top when removed from the top compartment exposes a drop down holding area inside the top compartment to store empty dog waste bags;
a bottom compartment is attached to the top compartment by a latch, the latch when open reveals an inside area in the bottom compartment the inside area holds a filled dog waste bag;
a locking clasp attached to the loop the locking clasp attaches the dog waste container to a harness or a leash handle; and
an outer mesh pocket on an outside surface of the dog waste container, the outside surface is shaped like a red fire hydrant.

12. The dog waste container according to claim 11 wherein the top compartment has a waste bag slot.

13. The dog waste container according to claim 11 wherein the outer mesh pocket is for keeping sanitary wipes or hand sanitizer.

14. The dog waste container according to claim 11 wherein the dog waste container is made of plastic and the loop is made of nylon.

15. The dog waste container according to claim 11 wherein the outside surface of the dog waste container has reflective strips.

16. The dog waste container according to claim 11 wherein the outer mesh pocket is for keeping dog treats.
